(19) United States
(12) Patent Application Publication
(10) Pub. No.: US 2002/0003206 A1
(43) Pub. Date: Jan. 10, 2002

(54) REMOTE AND INTEGRATED OPTICAL SENSING OF STATE, MOTION, AND POSITION

(76) Inventor: CRAIG F. CULVER, WOODSIDE, CA (US)

Correspondence Address: OPPENHEIMER WOLFF & DONNELLY, P. O. BOX 10356, PALO ALTO, CA, 94304, US

(21) Appl. No.: 09/204,641

(22) Filed: Dec. 2, 1998

Related U.S. Application Data
(60) Provisional application No. 60/067,381, filed on Dec. 3, 1997.

(51) Int. Cl. G06M 7/00; H01J 40/14

(52) U.S. Cl. 250/221

(57) ABSTRACT

Optical sensors and switches allowing remote sensing of motion, position, or state and permitting high-volume manufacture. An emitter outputs a beam of electromagnetic energy into an emitter channel integrally formed in a substrate or support structure. The beam is directed to a moving member having an encoder pattern in a sensor or a recess or control in a switch. A detector channel formed integrally in the substrate receives the beam when the encoder pattern or other object permits the beam to reach the detector channel. A detector located remotely from the encoder pattern receives the beam from the detector channel and outputs an electronic signal indicating that the beam is being detected. The emitter and detector can be included in a leadframe array that is integrated in the substrate. A second detector and second detector channel may also be included to allow the sensing of direction.

### CROSS REFERENCE TO RELATED APPLICATIONS

This application claims priority of provisional application Ser. No. 60/067,381, filed Dec. 3, 1997, entitled, “Interactive Panels for Instrument Control,” assigned to the assignee of the present application, and which is incorporated herein by reference.

### BACKGROUND OF THE INVENTION

This invention relates generally to sensing state, motion, and position in an electronic system, and more particularly use of optical signals for remote sensing of state, motion, and position in an electronic device.

Optical sensors are used in a variety of devices to sense the presence or absence of objects and the motion or position of objects. In a typical optical sensor, an emitter is provided which transmits a beam of light through a medium, such as infrared or visible light. A detector is used to sense the presence of the emitted beam of light. In “make beam” sensors, the detector normally detects no beam, and then detects the beam of light after it has been reflected from a reflective surface moved into the path of the beam. In “break beam” sensors, the detector normally detects the beam, and then detects the absence of the beam after an object or surface is placed to block the beam. In both types of optical sensors, no electrical or mechanical contact is made when sensing, thus allowing the sensor to have a long life without the wearing of parts.

Optical encoder sensors sense motion by providing a dark-light encoder pattern that causes the detector to alternately detect and not detect the beam; by counting the number of detections, an amount of movement can be determined. Quadrature encoding makes use of two detectors that are spaced in accordance with the encoder pattern so that the second detector receives light 90 degrees out of phase with the first detector. By comparing the two detected beams, the direction of motion can be determined. Optical encoders are used in may types of devices, including computer mice, trackballs, joysticks, or any other device in which motion, position, and/or direction of a member or component is sensed.

Optical fibers are used to direct light from one location to another, and can be useful for illuminating particular locations when an emitter must be remotely located from that location. The optical fiber is a discrete fiber having a cladding sheathing a light-conducting core to allow light to be transmitted from one end of the fiber to the other end. As an alternative to fiber optics, optical channels can be molded into an appropriate solid material. For example, optical channels can be used for illuminating buttons and other features on backlighting panels, such as panels manufactured by Lumitex Corp. of Strongsville, Ohio. In these panels, one or more point light sources (usually LEDs) are potted in a clear epoxy cement into one edge of a thin acrylic panel. Their visible light is beamed into the panel and is directed upward as required by particular treatments and processes. These panels are used for backlighting overlays, control panels, and other user interfaces in which visible illumination is required.

One problem in many devices that use optical encoders to sense motion or position is that space is limited so that emitters and/or detectors of the encoders cannot be easily placed near an encoder wheel or control surface. Some manufacturers have used optical fibers to allow more compact designs for encoders. For example, iO Tek of Seoul, Korea manufactures an optical-fiber computer mouse that employs infrared LED emitters local to the encoder wheel and uses optical fibers to conduct reflected light from the encoder wheel to remote photodetectors. Since the optical fibers can be flexed in any desirable angle, this allows the encoder to be used in very slim and compact device designs.

A problem with the existing use of optical fibers to conduct optical signals for encoding and detection purposes is that the fibers are hand-assembled in the housing of the device. This assembly process requires a significant amount of time and thus increases the cost of the device. In addition, such an assembly process may be suitable for first-stage production or low-volume products, but many high-volume applications can require higher levels of integration and automation for cost-effectiveness. What is needed is a more efficient, integrated optical sensor and switch that is suitable for high-volume, low cost manufacturing.

### SUMMARY OF THE INVENTION

The present invention provides optical sensors and switches that allow remote sensing and thus convenient placement in an electronic device and which include integrated optical channels for high-volume, low cost manufacturing.

More particularly, an optical sensor of the present invention includes a substrate or support structure, a moving member having an encoder pattern, and an emitter that outputs a beam of electromagnetic energy. A detector channel formed integrally in the substrate receives the beam when the encoder pattern permits the beam to reach the detector channel. A detector located remotely from the encoder pattern receives the beam from the detector channel and outputs an electronic signal indicating that the beam is being detected. Preferably, the emitter is also located remotely from the encoder pattern, where an emitter channel formed integrally in the substrate directs the beam from the emitter to the encoder pattern on the moving member.

The moving member can be a wheel rotatable about an axis or a linearly-moving member, for example. The moving member pattern can include a number of gaps and a number of blocking portions, where the gaps allow the beam to be transmitted to the detector channel. Or, the encoder pattern can include a number of portions having a reflective surface and a number of portions having a less reflective surface, such that the detector can distinguish which portion reflects the beam. The substrate is preferably made of plastic transparent to the beam, and the detector and emitter channels are molded in the substrate, such that at least one wall of the channels is reflective. In one embodiment, at least two walls of a channel are bordering an air gap in the substrate. The emitter and detector can be integrated in a lead frame array. A second detector and second detector channel may also be included to allow the sensing of direction of the moveable member. A method of the present invention provides similar features to the apparatus described. A different embodiment of an optical sensor of the present invention includes a flexible ribbon and flexible optical light pipes coupled to the ribbon, instead of the substrate and integral channels of the above embodiments.

An optical switch of the present invention includes a portion of a panel having a recess and an emitter outputting a beam of electromagnetic energy, where the emitter is coupled to the panel and is located remotely from the recess. An emitter channel is integrated in the panel and directs the beam from the emitter to the recess. A detector channel integrated in the panel receives the beam in a first state of the switch, and the detector channel does not receive the beam in a second state of the switch. A detector is located remotely from the encoder pattern and receives the beam from the detector channel. The detector outputs an electronic signal indicating one of the states of the switch.

Preferably, the detector channel receives the beam when a user causes an object, such as a finger of the user, to be placed in the recess such that the beam is reflected to he detector channel. Alternatively, the detector channel constantly receives the beam from the emitter until a user breaks the beam with an object, such as a finger, and the detector no longer receives the beam. The panel can be made of plastic transparent to the beam, where the detector channel is molded in the substrate, such that at least one wall of the channel is reflective. An illumination channel can also be molded in the panel which directs visible light from a second emitter located remotely from the recess to illuminate the recess when one of the states of the switch is entered.

Another embodiment of an optical switch of the present invention includes a moveable control movably coupled to a panel, where the control is manipulable by a user. An emitter located remotely from the control outputs a beam of electromagnetic energy and an emitter channel integrated in the panel directs the beam from the emitter to the control. A detector channel integrated in the panel receives the beam when the control is moved such that the beam is modulated to the detector channel. A detector located remotely from the control receives the beam from the detector channel and outputs an electronic signal indicating a state of the switch. For example, the control can include reflective and non-reflective portions about its circumference for reflecting the beam, or gaps to allow transmission of the beam. The control can be a rotary knob or a linear moving control. The optical channels can be implemented as described above.

The optical sensors and switches of the present invention provide accurate, reliable sensing devices which are cost-effective and easy to manufacture. The emitters and detectors can be positioned remotely from the moving element, thus allowing a great range of flexibility in placement of the encoder in suitable electronic devices. The optical channels of the encoders used for directing beams from emitters and to detectors are highly integrated and thus very suitable for automated, high-volume, and low cost manufacturing. The emitter and detector arrays described herein may be seated in the encoder substrate and allow further integration for even further decreases in cost and increases in automation and production.

These and other advantages of the present invention will become apparent to those skilled in the art upon a reading of the following specification of the invention and a study of the several figures of the drawing.

### BRIEF DESCRIPTION OF THE DRAWINGS

FIGS. 1a and 1b are top and side schematic views, respectively, of a first embodiment of an optical encoder of the present invention for sensing motion or position;

FIG. 2a is a perspective view of a suitable integrated optical channel for use with the encoder of the present invention;

FIG. 2b is a side elevational view of a support forming an optical channel in a substrate;

FIGS. 3a and 3b are top plan and side views of a second embodiment of an optical encoder of the present invention;

FIGS. 4a and 4b are top and side views, respectively, of a third embodiment of an optical encoder of the present invention;

FIGS. 5a and 5b are top plan and side views of a fourth embodiment of an optical encoder of the present invention;

FIG. 6 is a top plan view of a fifth embodiment of an optical encoder of the present invention;

FIGS. 7a and 7b are side elevational views of a sixth embodiment of an optical encoder of the present invention;

FIGS. 8a and 8b are top plan and side elevational views, respectively, of a seventh embodiment of an optical encoder of the present invention;

FIG. 9a is a top plan view of a tape for use with an optical encoder;

FIG. 9b is a top plan view of an eighth embodiment of an optical encoder of the present invention include a tape of FIG. 9a;

FIGS. 10a and 10b are side elevational views of a break beam optical switch of the present invention;

FIGS. 11a and 11b are side elevational views of a make beam optical switch of the present invention;

FIGS. 12a and 12b are top plan views of panels using the optical switches of FIGS. 11a and 11b;

FIG. 13 is a top plan view of a panel using the optical switches scanned in a grid;

FIG. 14 is a side elevational view of a panel including optical switches of the present invention;

FIG. 15 is a top plan view of a panel including optical switches and illumination of key recesses;

FIGS. 16a and 16b are top plan views of an optical switch of the present invention including a linear-moving control;

FIG. 17 is a top plan view of an optical switch of the present invention including a rotary knob control;

FIGS. 18a and 18b are top plan and side elevational views, respectively, of a panel for use in a vehicle and including optical circuits and controls;

FIGS. 19a and 19b are top plan and side elevational views, respectively, of a panel for use in an audio module and including optical circuits and controls; and

FIGS. 20a and 20b are side elevational views of a hybrid panel including both electronic circuits and optical circuits.

### DETAILED DESCRIPTION OF PREFERRED EMBODIMENTS

The optical sensing devices described herein are generally provided as either motion-sensing encoders and state-sensing switches.

Optical Encoders FIG. 1 is a schematic diagram of a first embodiment of an optical encoder 10 of the present invention. Encoder 10 includes a code wheel 12, an emitter 14, a detector assembly 16, a substrate 20, and channels 22a and 22b. Code wheel 12 is a cylinder that is rotatable about an axis A with respect to the other components of the sensor. The code wheel 12, for example, may be rotatably coupled to the substrate 20 or to a different surface grounded relative to the wheel's rotation. The wheel includes on its cylindrical side a regular coded pattern 24, such as regularly-spaced black and white (or dark and light) marks, where one type of mark is able to reflect emitted light, and the other type of mark absorbs or reflects light to a lesser degree that is sufficient to allow a detector to discriminate between the two levels of beam intensity. A detector can also be made to detect and discriminate between more than two intensities of the reflected beam for greater resolution. Such encoder wheels are well known to those skilled in the art.

Emitter 14 is positioned to direct electromagnetic energy, such as infrared or visible light, to the side of the code wheel where the pattern 24 is located. Emitter 14 is grounded with reference to the wheel 12. The emitter can be any of a variety of types of optical components, including a LED, photodiode, etc. The emitted light beam from emitter 14 is shown as arrows 26. The light is directed into channels 22a and 22b of the substrate 20. Substrate 20 is a support structure preferably made of a low-cost plastic, such as acrylic, or similar material which can be formed or altered with molds. Substrate 20 is a transparent material to the beam emitted by the emitter 14, allowing a desired wavelength of light to be transmitted through the substrate.

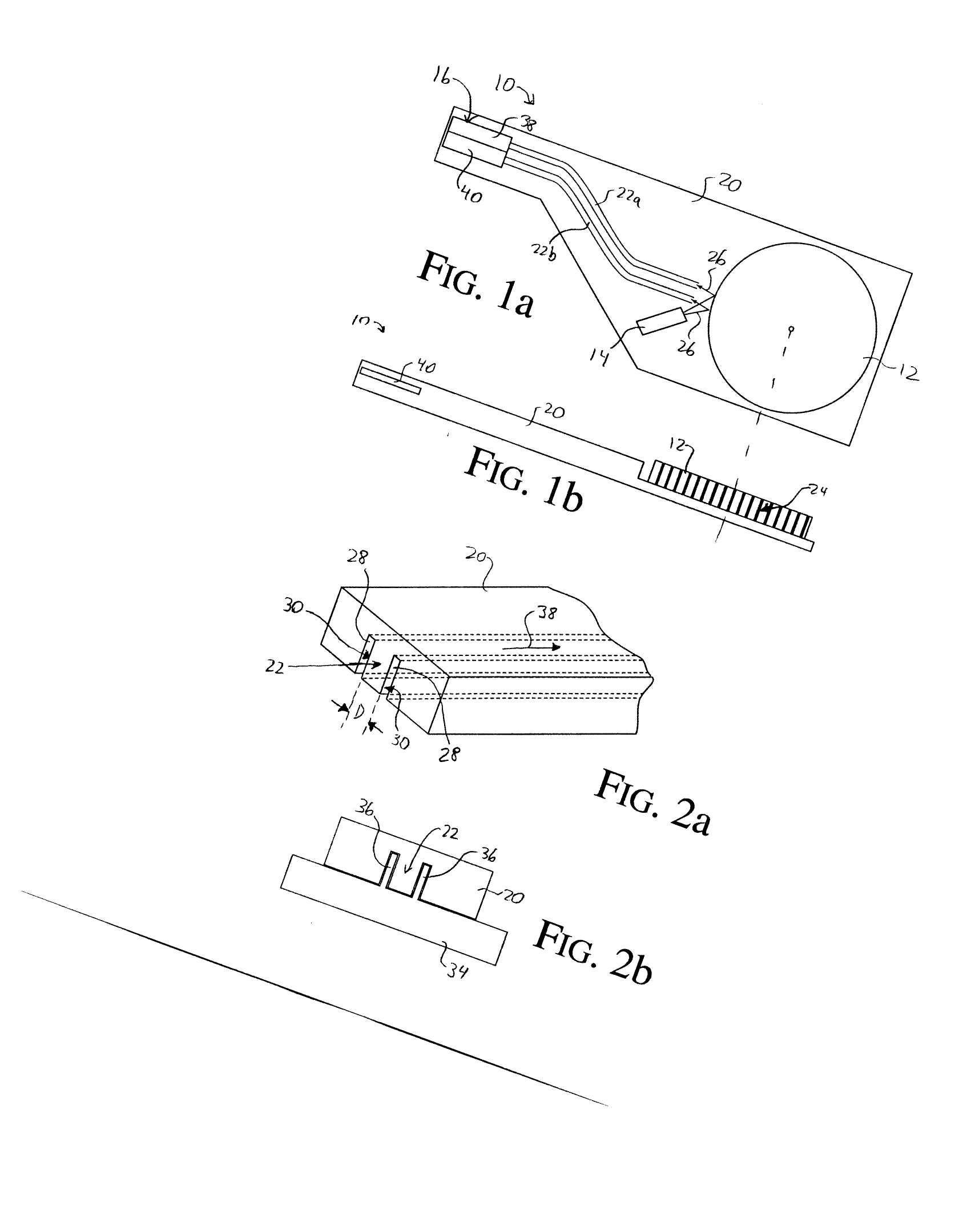

Channels 22a and 22b are integrated in the monolithic substrate 20. Herein, the term “channel” is intended to refer to a path of light within a substrate that is controlled and defined by features provided in the substrate. For example, channels 22a and 22b can be a pathway defined by walls molded into the substrate, as shown in FIG. 2a.

FIG. 2a shows one example of a molded channel 22 that is formed or integrated in the substrate 20 and which is suitable for use with the present invention. Channel 22 is defined between two air gaps 28 which are spaced apart by a predetermined distance D. The gaps 28 each have an inner surface 30 bordering the channel 22 which is polished to a smooth finish. The inner surfaces 30 act as reflective surfaces to any light entering the channel. Thus, if light enters the channel 22, it will move down the channel in direction 32 since the reflective inner surfaces prevent the light from moving in other directions. One advantage of using reflective walls in the channel is that the light may be directed much further without the significant scatter attenuation that would occur without reflective walls. In other embodiments, third and/or four walls can be provided to further surround the desired pathway of the light beam. The channel 22 can also be routed at different angles and curved or angular pathways, with angled reflective surfaces placed at appropriate angles to direct the light in the desired directions. The light may be both reflected and refracted (e.g., using materials of differing densities) to direct it in desired directions. Channel 22 may also be tapered, where one end of the channel is wider than the other end. The techniques for making such molded channels and providing light control within a substrate such as a panel are well known; for example, the making of such channels in materials to provided a path for emitted light is performed by Lumitex Corp. of Strongsville, Ohio, which make optical channels for illuminating plastic panels.

FIG. 2b illustrates one example of making a channel 22 in substrate 20. A mold section 34 is provided in a mold for plastic substrate 20. Mold section 34 includes two ribs 36 having a small width and spaced apart at a desired width for the channel. When heated, soft plastic of substrate 20 is flowed into the mold cavity, the plastic flows around the ribs 36 and cools so that so that gaps 28 are formed around the ribs 36 in the solidified plastic. When the substrate 20 is removed from the mold section 34, air gaps 28 remain in place. Since the ribs 36 are provided with very smooth, polished surfaces, the surfaces of the air gaps 28 are also smooth, which is desirable to provide reflective properties (only the surface of the gap 28 facing the channel need be smooth and reflective). In other embodiments, the molded channels can be formed by precisely molding or inserting elements having reflective surfaces within the substrate. For example, instead of providing air gaps 28, thin elements can be inserted into the plastic, the elements having highly polished surfaces on the sides facing the channel to contain a light beam within the channel area.

In other embodiments, channels 22a and 22b can be implemented in other ways. For example, a beam of light can be directed through the substrate without reflective walls, and integrated molding features such as reflective surfaces can be provided in the substrate which are angled to direct the light in a desired direction. Such a channel embodiment is described below with respect to FIG. 7a and 7b. In such an embodiment without walls parallel to the light path, other features such as a molded slit and/or a molded lens can be provided at the emitter, pickup points, and/or detector to direct the light to the desired location (and if angled reflected surfaces are made narrow enough, they can act like slits to direct only light beams aimed directly at the reflective surface). Other types of channels may include baffling walls which do not reflect the light beam but prevent the beam from interfering with other optical circuits and detectors. In still other embodiments, reflective walls as described above need only be provided over a portion of a light beam's path and not the full length of the path, e.g. only at the points where the light is directed around curved or angled paths.

Referring back to FIG. 1, two channels 22a and 22b are provided in a phased relationship and each directs a separate light beam. The two channels are preferably spaced apart by a small distance to allow the ends of the channels to both pick up light from single emitter 26. In an alternate embodiment, two emitters can be used, one emitter for each channel 22. A small gap is provided between the channels 22 and the code wheel to allow the code wheel to be rotated. The channels 22a and 22b direct the light 26 emitted by emitter 26 along the length of the channels. Channels 22a and 22b are shown as curved in the described embodiment to emphasize that the light beams can be directed along a path of any shape as dictated by the constraints of packaging, housing, etc. of a device, panel, etc. Detector assembly 16 is positioned to receive the light from the channels 22a and 22b. Assembly 16 includes detectors 38 and 40, where detector 38 receives the light from channel 22a and detector 40 receives the light from channel 22b. Detectors 38 and 40 can be any of a variety of light-sensing detectors, such as photodiodes, photoresistors, phototransistors, etc.

Encoder 10 operates as an optical reflective encoder to sense the amount and direction of rotary motion (or position) of code wheel 12. The light 26 is only transmitted through the channels 22a and 22b when a white (or other reflective) mark of pattern 24 receives the emitted light, and the light is not transmitted when a non-reflective mark of pattern 24 receives the light. Motion of code wheel 12 is sensed by determining how many marks have been detected during rotation of the wheel. Preferably, two detectors 38 and 40 and two detector channels 22a and 22b spaced at a predetermined distance apart at their receiving ends are used to provide quadrature encoding, which allows the direction of motion of code wheel 12 to be determined as well as the amount of rotation of the wheel, and is well known to those skilled in the art. Wheel 12 can be coupled to any rotating member such that the position of the rotating member is known using encoder 10. For example, the wheel can be coupled to a rotating member in an interface device to a computer, where the position of the interface device controls the position of a cursor in a computer-displayed graphical environment. The encoder 10 can also be used with known methods for increasing resolution, such as refractive prismatic code wheels and interrupters in place of slots or marks. In other embodiments, the positions of the emitter and decoder can be reversed, such that the emitter is located remotely from the pickup point and the detector is located local to the pickup point.

The encoder 10 has several advantages over other types of optical encoders. One advantage is that the detectors are positioned remotely from the pickup point (the actual point adjacent to the moving code wheel or strip at which light enters the detecting apparatus). The channels 22a and 22b may be made as long as desired for a particular application, limited only by the transmission characteristics of the medium, to allow the detectors to be positioned anywhere space allows in a device. Remote detectors allow an increase in reliability and a decrease in size and cost, as well as manufacturing simplicity and improved flexibility in package design. Another advantage is the elimination of a second pickup point for the second detector, since the channels are spaced closely enough at their pickup ends to detect a single modulated light signal at one common point. The second channel pickup is slightly offset from the first channel pickup, thereby detecting the phase differential for directional data. Another advantage is that the dimensions between the channels 22a and 22b at the pickup point can be matched to the dimensions of the moving code pattern 24 to provide a phase difference of 90 degrees at the detectors 38 and 40, as needed for quadrature encoding, i.e. the phasing and positioning dimensions are a function of the mold of the substrate and channels. Since the channels 22 are molded in substrate 20 at the desired dimension apart in accordance with the pattern 24, inherent optimum phasing between channels results, and there is no risk of improper distancing between the detectors and no risk of undesired movement between the detector pickup points during use of the encoder. For example, if 1 mm line width and spacing of pattern 24 is used, the openings of channels 22 at the wheel 12 can be 0.5 mm in width and positioned adjacent to each other to provide properly phased signals. Furthermore, the small size of the openings of the channels 22a and 22b allows the channels to pick up the emitted light without the use of additional precisely-positioned phasing slits or other collimating/focusing elements. Another advantage is the simplicity of the assembly of the encoder 10 of the present invention: the entire encoding circuit need only include four distinct components, light emitter, moving pattern, light channel, and light detector. Due to the inherent alignment and phasing in the encoder design, assembly may be highly automated. A final advantage is the low cost of the device: manufacturing processes suitable for automated, high-volume production and low assembly cost may be used, and the optoelectronic components (code wheels, emitters, detectors) are inexpensive and widely available.

In alternate embodiments, multiplexing can be used. For example, a number of code wheels and associated emitters can be provided, each having a channel 22 to a single detector (or a single pair of detectors). Each channel's code wheel is sequentially illuminated by an emitter while the synchronized detectors look for any movement of the wheel since the last scan. A microprocessor or other controller can sequentially scan several channels with a single pair of detectors. In still other embodiments, multi-phase encoding using more than two phases can be used. For example, four or eight-phase encoding can be used by adding additional channels and detectors, to allow increased sensor resolution.

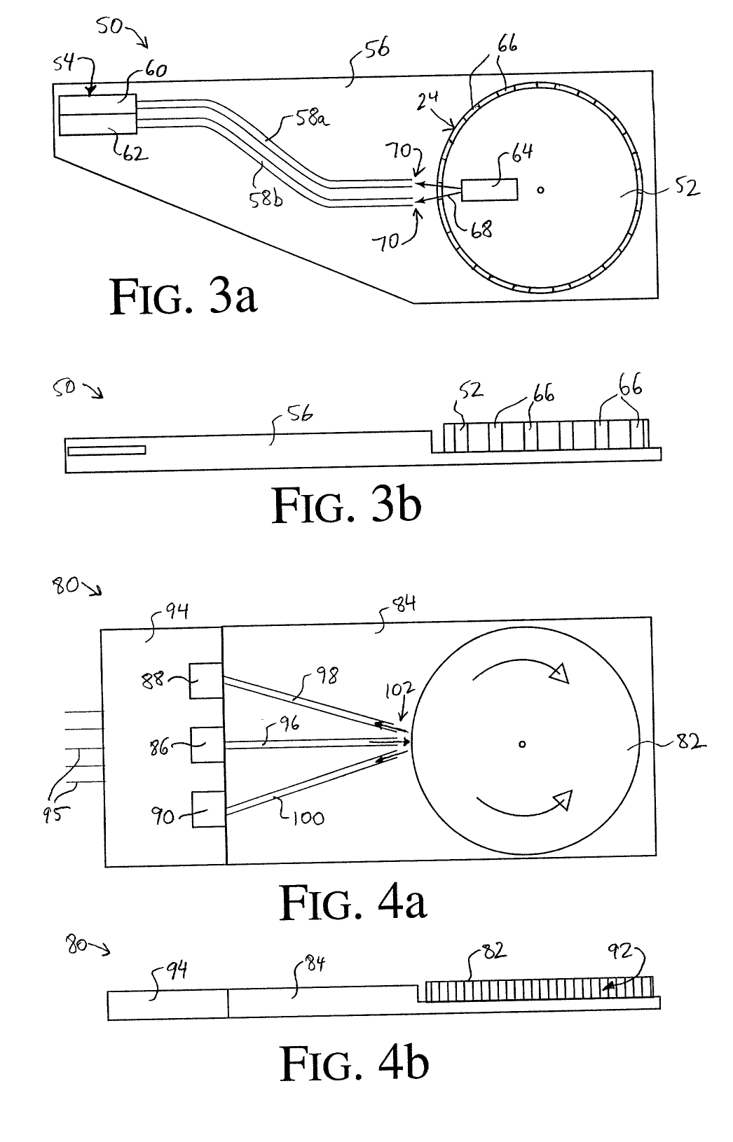

FIGS. 3a and 3b are top plan and side elevational views, respectively, of an alternate embodiment 50 of the encoder of the present invention. Encoder 50 includes a code wheel 52, detector assembly 54 including detectors 60 and 62, and molded channels 58a and 58b integrated in a substrate 56, similar to equivalent components described above with reference to FIG. 1. Code wheel 52 preferably includes gaps 66 its circumferential surface spaced according to a similar pattern as the marks of pattern 24 described for FIG. 1. In encoder 50, emitter 64 is positioned on the opposite side of gaps 66 from the channels 58a and 58b. Light 68 emitted from emitter 64 is directed at the openings 70 of the channels 58a and 58b. When a gap 66 is positioned in the path of the light 68, the light is able to reach the channels 58a and 58b, and when a portion between slots is positioned in the path of the light, the light is blocked from impinging on the channels. As the code wheel 52 rotates, the light is intermittently interrupted, thus modulating the light received and transmitted by the channels 58a and 58b. The operation of such transmissive optical encoders are well known to those skilled in the art.

FIGS. 4a and 4b are schematic diagrams of a third embodiment 80 of an optical encoder of the present invention. Encoder 80 includes a code wheel 82, a substrate or panel 84, an emitter 86, and detectors 88 and 90.

The periphery (circumferential surface) of the code wheel 82 is printed with a contrasting dark-light encoding pattern 92, as shown in FIG. 4b, and similar to the pattern 24 described above. Emitter 86 and detectors 88 and 90 are preferably integrated on a common leadframe array 94 that is cast in place in the panel 84 and has leads or traces 95. Furthermore, other discrete elements or components may also be integrated on the leadframe array 94 with the emitter and detectors. Channels 96, 98 and 100 are molded into and integrated with the panel 84. Emitter 86 outputs light, such as infrared light, which is guided by molded emitter channel 96 toward the code wheel 82. The light illuminates the encoding pattern 92, causing light to be reflected into the two detection channels 98 and 100 which in turn guide the light to detectors 88 and 90, respectively. The detection channels 98 and 100 are positioned to produce quadrature phasing of the two return light beams. The detectors 88 and 90 convert the received light beams into phased electrical signals, which supply distance and direction information relative to rotation of code wheel 82 to conventional electronic circuitry.

The embodiment 80 has several advantages. Both the detectors and the emitters are positioned remotely from the pickup point 102 where the light reflects from the encoding pattern, allowing more efficient designs and greater flexibility in packaging. Furthermore, the emitter and detectors are integrally provided in a single leadframe array, allowing simple manufacture of the parts and high-volume production. In the fully-integrated encoder, all elements can be incorporated into the leadframe capsule except the code wheel or moving pattern. Since the emitter and detectors are positioned remotely from the pickup point, there are fewer restrictions on integration than in the prior art direct sensing structures, which have significant mounting limitations. Alternatively, the emitter and detectors can be individually potted in a clear epoxy cement onto the edge or in an aperture in the panel 84, which can be a thin acrylic panel. The emitter and detectors thus would be surrounded by the substrate material to maximize optical coupling. This allows the emitted light to be transmitted directly into the substrate material without attenuation, and allows the detected light to be similarly transmitted directly to the detectors.

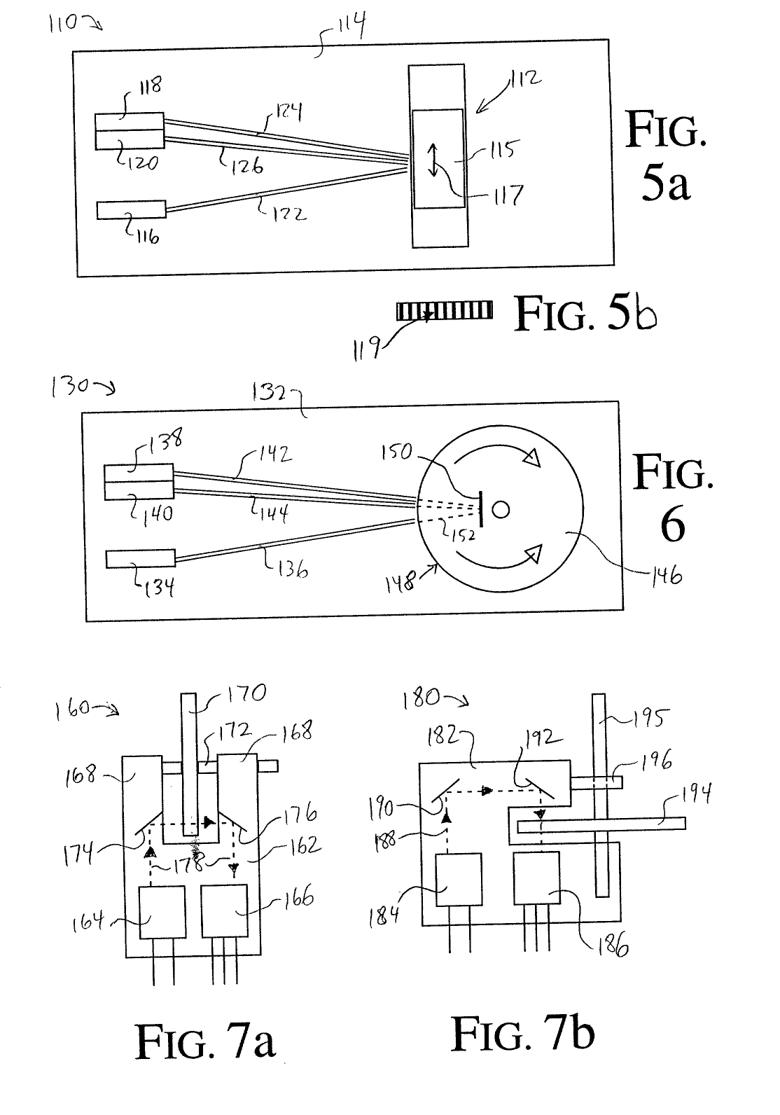

Another advantage of the embodiment 80 of the encoder is that the two detection channels 98 and 100 are positioned to surround the emitter channel 96. This allows light to be detected equally on either side at each detection channel at the pickup point after the light reflects from the code wheel, rather than having one detection channel receive more reflected light than the other detection channel. This arrangement can also be used in the embodiments of FIGS. 5 and 6, and/or can be incorporated into a plastic optical panel including optical switches as described below. In alternate embodiments, the detectors 88 and 90 and the detection channels 98 and 100 can both be positioned on one side of the emitter 86 and the emitter channel 96, similar to the encoder 110 of FIG. 5, below.

FIG. 5a is a schematic diagram of a fourth embodiment 110 of an optical encoder of the present invention. Encoder 110 includes a linear element 112, a substrate or panel 114, an emitter 116, and detectors 118 and 120. Panel 114, emitter 116, and detectors 118 and 120 are similar to the equivalent components as described in the embodiments above. Panel 114 includes an emitter channel 122 and two detector channels, 124 and 126, similar to the channels described above. The two detectors and detector channels are shown positioned together to one side of the emitter 116 and emitter channel. Alternatively, an arrangement where the emitter and emitter channel are positioned between the detectors and detector channel, as shown in FIGS. 4a and 4b, can be provided.

Linear element 112 includes a moving code element 115 which can slide in either direction in a linear degree of freedom, as shown by arrow 117. As shown in the side view of FIG. 5b, moving code element 115 includes a dark-light coding pattern 118 similar to the patterns described in the embodiments above, except that the pattern is printed on the straight surface of the side of element 115 rather than the curved surface of a wheel.

Operation of the encoder 110 is similar to the encoders described above. Light from the emitter 116 is directed down the emitter channel 122 and is directed at the element 114 at the pattern 119, where the light is reflected from the pattern if a lighter portion receives the light and the light is not reflected (or reflected much less) when a darker portion of the pattern receives the light. Reflected light is directed to the openings of the channels 124 and 126 and to the detectors 118 and 120. Since the openings of the channels 124 and 126 are spaced in accordance with the pattern 119 to provide proper quadrature phasing, use of the two detectors allows the determination of both magnitude and direction of motion of the moving element 115. The element 115 can be coupled to any moving element of a mechanism or device to measure the linear motion or position of that element.

FIG. 6 is a schematic diagram of a fourth embodiment 130 of an optical encoder of the present invention. The encoder 130 includes a substrate or panel 132, an emitter 134, an emitter channel 136, two detectors 138 and 140, and two detector channels 142 and 144, which emit, direct, and receive electromagnetic energy similarly to the equivalent components described above. Encoder 130 further includes a slotted code wheel 146 having a slotted surface 148; code wheel 146 is similar to the code wheel 52 described in FIG. 3. A fixed reflective surface 150 is preferably positioned on the other side of the slotted surface 148 from the emitter 134 and detectors 138 and 140, and is grounded with respect to the rotating code wheel 146. Surface 150 is positioned such that the beam 152 emitted from emitter 134 and passing through a slot in surface 148 impinges on the surface 150 and is reflected back through the surface 148 to the detection channels 144 and 142 and thus to detectors 138 and 140. Preferably, the fixed reflective surface 150 is molded into the panel 132, e.g., a “skirt” can extend down from the rotating wheel into a circular slot in the panel 132, with the surface 150 molded in the center area of the skirt. Alternatively, the surface 150 can be coupled to a different grounded surface. In yet other embodiments, the surface 50 can be removed and the detectors 138 and 140 and detection channels 142 and 144 can be positioned on the opposite side of the code wheel 146 from the emitter 136. This would allow the beam 152 to pass through the entire code wheel 146 to the detectors when slots in the code wheel are positioned appropriately, and block the beam when the code wheel is moved so that the blocking portions of the surface 148 are positioned in the path of the beam.

FIGS. 7a and 7b illustrate a fifth embodiment of an optical encoder of the present invention. FIG. 7a shows one embodiment 160 of a transmissive encoder having a vertically-aligned code wheel. A plastic frame 162 is provided which is transparent to a particular wavelength of light to be used in the encoder. An emitter 164 and a detector 166 are potted into one end of the frame 162 with an epoxy or other encapsulant. At the other end of the frame, extension arms 168 support a code wheel 170 on a rotatable shaft 172. The emitter channel in this embodiment includes a reflective surface 174 that is integrated in frame 162 to receive a light beam 178 emitted from emitter 164 and direct the beam toward the code wheel. Similarly, the detector channel includes a reflective surface 176 is positioned in frame 162 to redirect the beam toward the detector 166. The reflective surface can be molded into the frame 162 similarly to the channels described above, or it can be the surface of a plate or other object embedded in the frame.

In operation, the beam 178 is emitted from the emitter 164 and is redirected approximately 90 degrees by surface 174 toward the code wheel 170. Code wheel 170 has slots which allow the beam to pass through the wheel, interspersed with opaque sections which block the beam. When the beam is allowed to pass through the wheel, the surface 176 redirects the beam another 90 degrees toward the detector 166. Motion is detected by determining when the beam is blocked and when it is detected. Two detectors can be provided in embodiments having quadrature encoding, where the second detector is spaced at a distance from the first encoder in accordance with the pattern on the wheel 170. In addition, the emitter and detector can be provided as separate components potted into a frame 162, or they can be mounted on a common leadframe, where the reflective surfaces and codewheel support are cast into the leadframe encapsulant. Furthermore, additional features can be integrated in the frame 162 to help direct the light beams to desired locations and/or block light from interfering with other components. For example, a reflective surface or gap, or a baffle can be placed between emitter and detector to help guide the light beam to the encoder wheel and detector and to prevent any stray light from being transmitted to the detector. Alternatively, channels with walls as described in the embodiment of FIG. 1 can be used to direct the light as desired.

FIG. 7b shows another embodiment 180 of a transmissive encoder that is similar to the embodiment 160, but includes a code wheel 194 having an orientation orthogonal to the code wheel of the embodiment 160. In embodiment 180, code wheel 194 is supported by a rotating shaft 195 that is rotatably coupled to an extension 196 from a frame 182. Emitter 184 and detector 186 are placed in frame 182, where the emitted beam 188 is reflected 90 degrees first from reflective surface 190 and then from reflective surface 192, before the beam impinges on (or passes through) the code wheel 194 to the detector. The operation is similar to the embodiment 160 of FIG. 7a. In alternative embodiments, the emitter and detector positions can be reversed.

FIGS. 8a and 8b are diagrams showing a top plan view and a side elevational view, respectively, of a sixth embodiment 200 of an optical encoder of the present invention. Encoder 200 includes a code wheel 202, emitter 204, and detectors 206 and 208, similar to the embodiments above. Instead of a substrate or panel, however, encoder 200 includes a flexible ribbon 210 which can be similar to a flexible-circuit electrical interconnect ribbon in common electronic devices. The optoelectronic components such as emitters and detectors (and/or switches, traces, etc.) can be discrete elements that are adhered to the ribbon 210 with an adhesive. A film is laminated over the components, and electrical traces 218 on the ribbon can be connected to these components and terminate at connection points at the end of the ribbon. Instead of molded channels for directing light, flexible optical fibers can be positioned on the ribbon 210 to direct light. Thus, an emitter fiber 212 is laminated or otherwise coupled to the ribbon 210 so that one end picks up light from the emitter 204 and the other end directs the light onto the pattern 213 of the code wheel 202. Two detector fibers 214 and 216 are also coupled to the ribbon 210 to receive light reflected from the pattern 203 and direct the light back to detectors 206 and 208, where the light is properly phased for quadrature encoding.

The encoder 200 has several advantages. The ribbon can be very thin, allowing the encoder to placed in areas of devices having restricted space. The overall thickness of the encoder is limited by the thickness of any individual component; excluding emitters and detectors, the thickness of the wheel and fiber/ribbon need not exceed about 1 mm, for example, including 0.5 mm fibers and laminate films. Another advantage is the flexibility of the encoder. The optical ribbon may be flexed to conform to packaging requirements. Locating holes, such as holes 220, may be die-cut into the ribbon 210 to decrease assembly times and insure precise and rapid positioning and registration with respect to the code wheel 202. Furthermore, common production processes exist which can perform the positioning, lamination, and necessary cutting and forming at high speed and required precision.

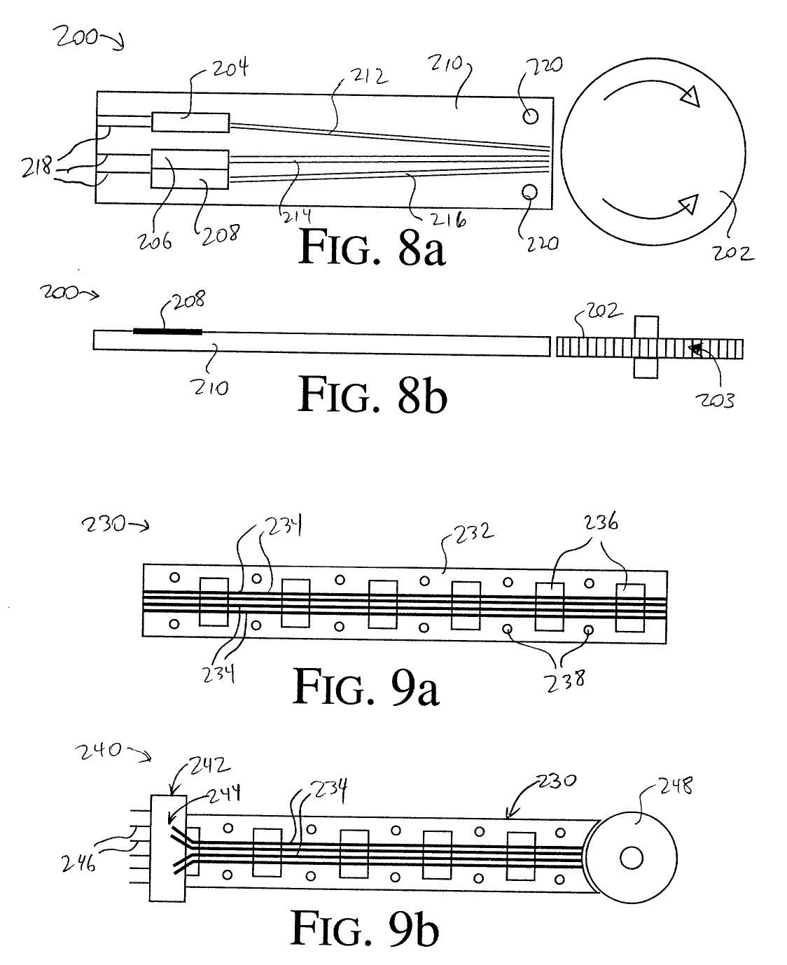

FIGS. 9a and 9b illustrate a seventh embodiment of an optical encoder of the present invention. In this embodiment, a portion of the encoder is provided on a flexible strip of tape, similar to the ribbon 210 of the embodiment of FIGS. 8a and 8b. As shown in FIG. 9a, tape 230 can be provided in long lengths (e.g. stored in rolls) and can be cut to obtain a section of tape having the desired length for a specific application. Tape 230 includes an adhesive-bearing film substrate 232 on which have been laid flexible light pipes, such as optical fibers 234 oriented approximately parallel and having a size, spacing and number specified by the specific application. The optical fibers are fixed in position on the substrate by an overlay film. Periodic cutout holes 236 are preferably provided in the substrate 232. The tape 230 may be cut at any of the cutout holes 236 to provide a tape of desired length and to allow access to the individual fibers 234 so that the fibers may be connected to appropriate components. Die-cut registration holes 238 in the substrate 232 allow rapid and precise positioning of the tape in a device relative to other components of encoder, described below.

FIG. 9b shows the placement of tape 230 in an optical encoder 240 that is used to measure motion in a device. Tape 230 has been cut to a desired size and placed in a device using registration holes 238 as a guide onto mating pins of the device; this allows rapid and precise positioning of the tape in a device relative to other components, such as encoder wheel 248 and array 242.

At one end of tape 230 is placed an optoelectronic array 242, which may include components such as emitters, detectors, fiber terminations, and electrical terminations. For example, the fibers 234 at ends 244 may be connected to terminals of emitters and/or detectors that transmit or receive light passing through the fibers. Leads 246 of the array 242 may be connected to other electrical components in the device.

At the opposite end of the tape 230, an encoder wheel 248 is positioned such that light directed out of at least one fiber 234 may impinge on the pattern of the wheel and be reflected back to other fibers 234 which direct the light to one or more detectors. The pattern on the wheel is correlated to the spacing of the fibers 234 at the pickup point to provide the appropriate phase difference in detection. Code wheel 248 is coupled to a member or component that causes code wheel 248 to rotate when the member moves, thus allowing the sensing of motion of the member. In alternate embodiments, instead of wheel 248, a linear code element may be used, similar to the linear element shown with respect to FIG. 5.

The assembly of the encoder 240 can be performed in a few easy steps. The tape 230 is cut to a desired length in a jig, or is provided at a precut length. The fibers 234 are then inserted into the appropriate fiber terminations on the array 242. The tape is then inserted into the device so that the registration holes mate with registration pins of the device. The code wheel is then inserted to complete the encoder assembly. Encoder 240 allows remote emitters and/or detectors to be used in an easily-housed encoder. Since both the ribbon and the fibers are flexible, the encoder can be conveniently bent and curved to fit in particular spaces in a device, which is not possible with other forms of encoders.

### Sensing States with Optical Switches

The present invention uses optical components as switches to sense states as well as motion. States to be detected include the positional state of a switch (on or off), the position of a knob (positions A, B, C, etc.), the press of a pushbutton, or the actuation of a proximity switch. Light can be modulated in transmissive or reflective embodiments by finger contact, depression of an overlay or snap dome, depression of a discrete key, or the movement of a control such as a knob or sliding switch to move gaps or encoder patterns. Optical switches may interfere with an emitted light beam to detect state (the “break beam” type) or cause a beam to be reflected to a detector (the “make beam” type), or modify the polarity of light for detection by multiple polarized sensors. A number of embodiments of optical switches follows below.

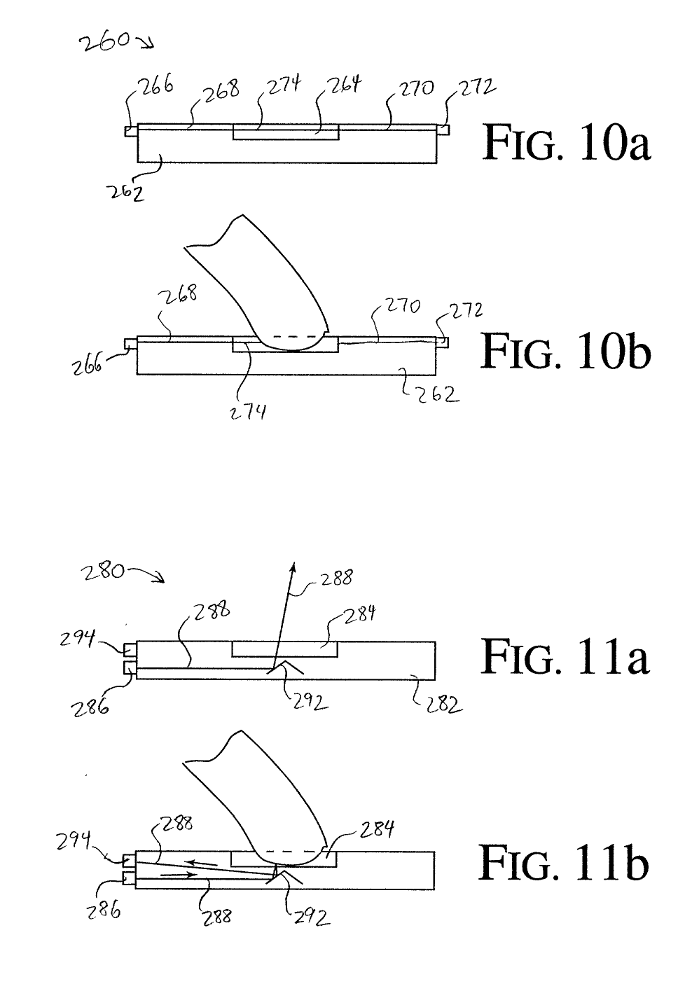

FIG. 10a is a side elevational view of an optical switch 260 in which state is sensed and the beam is modulated by breaking the emitted beam (a “break beam” type switch). A panel 262 is provided with a recess 264. An emitter 266, such as a light emitting diode, is positioned on one side of the recess and a light pipe 268, such as an optical channel as described in the encoder embodiments above, directs the light from the emitter to the recess 264. The light then is transmitted across the recess as beam 274 and is received by the light pipe 270 at the opposite end of the recess. Light pipe 270 is similar to light pipe 268, and directs the light to a detector 272. In the described embodiment, the light pipes 268 and 270 are substantially linear, but in other embodiments the light pipes may be curved or angled as desired to direct the light from the remote emitter 266 and to the remote detector 272. As shown in FIG. 10b, the user may change the state of the optical switch by simply inserting a finger or other object within the recess 264 so that the beam 274 from the emitter is broken and does not reach the detector. In some embodiments, a key or other object can be provided over the recess 264 such that when the key is pressed, the beam is blocked. For example, a flexible film overlay can be applied over the recess. When finger pressure depresses the overlay, the overlay deforms and breaks the light beam. The electronic device connected to the detector 272 can read the change in state and perform the appropriate task or function in response.

FIG. 11a is a side elevational view of an optical switch 280 in which a change in state (modulation of the light) is sensed based on the transmission of a beam to a detector (a “make beam” type switch). A panel 282 includes a recess 284. An emitter 286 outputs a beam 288 of light which is directed by a light pipe, such as an optical channel, of the panel 282 to a reflective surface 292. The optical channel can include a reflective surface 292 reflects the light into the recess 284, and the beam is transmitted away from the recess so that the detector 294 does not detect the beam. In other embodiments, the beam 288 can be reflected in other directions as desired to be emitted into the recess. As shown in FIG. 11b, a user may change the state of the optical switch by inserting a finger or other object within the recess 264 so that the beam 288 is reflected back into the panel 282 to the reflective surface 292 and is directed to the detector 294. The electronic device connected to the detector 294 can read the change in state.

In another embodiment, the state of a switch can be sensed based on physical deflection of optical fibers. When an optical fiber carrying light is bent beyond a specific angle, light begins to pass out of the fiber, and the remaining light in the fiber is attenuated. The drop in light intensity can be detected as a change in switch state. For example, a pair of fibers can be laid over a recess, with light constantly being emitted at one end and detected at the other end of the fibers. The user can touch and bend the fibers when inserting a finger into the recess, causing the light attenuation and a detection of change of state. Alternatively, the optical fibers can be attached to a flexible membrane that flexes when touched, so that both membrane and fibers are bent when a user presses the keyswitch.

FIG. 12a is a schematic drawing of an example of a two-keyswitch lighted switch panel 300 using optical keyswitches of the present invention. Panel 300 includes a support 302, on which is located an array 304. Array 304 is preferably a single lead frame that includes all the light sources (such as emitters) for illumination and sensing state as well as all the detectors needed for sensing state. The array 304 can be embedded into the panel, such as in an optically-transparent epoxy cement, resulting in a one-piece panel component. Discrete optical components can alternatively be used.

Recesses 306 and 308 are provided in the support 302 as the locations of the “button” or switch for the user to activate. Light pipes 310 and 312, such as optical channels, carry emitted, visible light from an emitter on the array 304 to the recesses 306 and 308, respectively, to selectively illuminate the recesses. Reflective features in the recesses allow the visible light to be spread about the recess to illuminate it, as is well known to those skilled in the art. Light pipes 314 and 316, such as optical channels, are used to transmit emitted light from different emitters on array 304 to the recesses 306 and 308, respectively. Light pipes 318 and 320 are used to transmit light that has been reflected from an object inserted into the recess 306 and 308, respectively, back to detectors on the array 304. Thus the panel functions as follows, using the key of recess 306 as an example. In the key's off state, the emitted light from light pipe 314 is directed into the recess 306 and away from the detection light pipe 318. When a user inserts a finger or object into a recess, the light from the light pipe 314 in the recess is reflected back to the detection light pipe 318 and is transmitted to a detector on array 304, which thus detects a change in state. The keyswitch for recess 308 functions similarly. Preferably, the light from the switch emitters is not visible to the user, e.g. infrared light. The light from the illuminating emitters is visible since it used to illuminate a keyswitch; for example, a keyswitch (recess) can be illuminated after the keyswitch has been actuated (finger or object inserted), and the illumination can be turned off when the keyswitch is pressed again. In other embodiments, a break-beam type of sensor can be used instead of the described make-beam sensors.

FIG. 12b illustrates a key panel 330 similar to the panel of FIG. 12, except that nine keys 332 are provided. As described for the panel of FIG. 12a, each of the keyswitches 332 preferably illuminates when it is actuated and then is not illuminated when the keyswitch is actuated again. An array 334 preferably integrates all the optical components for the panel, such as emitters and detectors. Light pipes (not shown) provide the light to the keys for illumination and state detection and direct light back to detectors on the array for detection.

FIG. 13 is a top plan view of another key panel 350 that includes an optical scanning matrix. A grid of recesses 352 in the panel 350 each function as a keyswitch in the panel. A number of emitters 354 are provided along one side of the recesses 352 and each emit a beam down a light pipe 356, such as an optical channel, extending down each row of recesses such that one beam can be directed across all the recesses in the row. A number of detectors 358 are provided orthogonally to the emitters, and each detector receives light from an associated light pipe 359 extending down a column of recesses. The state of a switch is changed by either breaking or making a beam, as described in the embodiments above. To determine which particular keyswitch has been actuated, the emitters can consecutively emit beams in a looping or scanning fashion. When a keyswitch is actuated, the emitter scanning at the time of the actuation is noted to find the row, and the detector that detects a switch state determines the column, thus allowing the particular keyswitch actuated to be known. Such optical scanning over a grid for detection is well known to those skilled in the art. The light emitted by the emitters can also be oscillated (in any of the embodiments described herein); the emitters and detectors can operate at a high frequency to increase immunity to spurious light and increase sensor immunity to illumination within the panel, or can operate at coded frequencies (or coded intensities) to allow the light to be distinguished from interfering light.

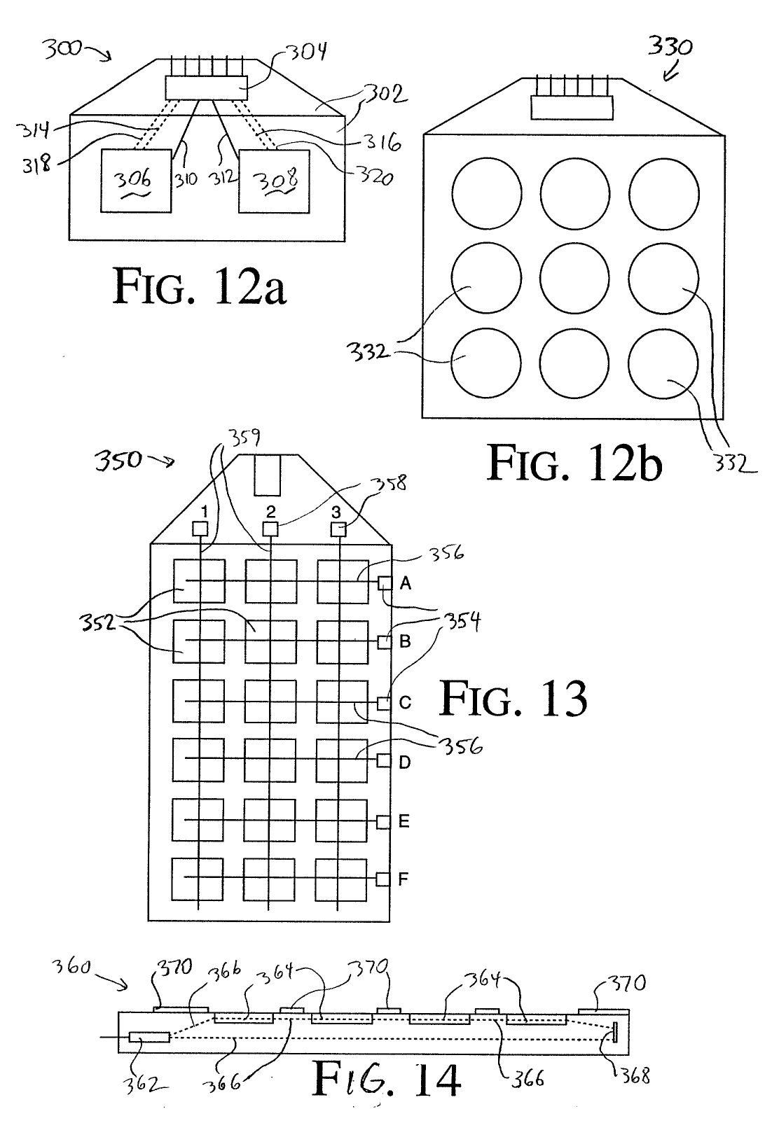

FIG. 14 is a side elevational view of a panel 360 having optical keyswitches as shown in the embodiments of FIGS. 12a, 12b, and 13. Recesses 364 are provided in the panel 360, and an integrated emitter-detector array 362 is provided at one side of the panel. Both illuminating emitters and sensor emitters are included in the array. Light channels 366 are molded into the panel 360 to direct the emitted light to keyswitch recesses and back to the detectors on the array 362. A reflective surface 368 can be molded in the panel and used to direct the emitted beam of light through the recesses and back to the detector. The beam of light can be directed across all the recesses in a row, as in the embodiment of FIG. 13. Alternatively, each recess can be provided with its own beam of light. Furthermore, tactile, graphic, and appearance features 370, such as rims for the keyswitches to aid the user in locating the keyswitches, may be molded and/or imprinted onto the top surface of the panel.

FIG. 15 is a schematic diagram of a panel 380 having selective illumination of keyswitches. Panel 380 includes a number of keyswitch recesses 382 as described above. Emitters 384 are provided at one side of the panel and emit visible light of one color. Channels 386 can be molded into the panel to direct light from the each emitter 384 to an associated keyswitch recess 382. In some cases, the channels can use refraction or diffraction to direct the light in particular directions; for example, an air gap, having a different density than the substrate material, can refract a beam when the beam passes into the air gap. Emitters 388 can be provided at another side of the panel and emit visible light of a different color than the light emitted by emitters 384. Molded channels 390 direct light from each emitter 388 to an associated recess 382. Each recess 382 thus may be illuminated by either an emitter 382 or an emitter 388 (or by both emitters simultaneously). Optical switches (not shown) are also provided for each keyswitch as described in the embodiments above to detect the state of the keyswitches. When a keyswitch is in one state, it is preferably illuminated by one color of light from one emitter 384, and when the keyswitch has another state, it is illuminated by the other color of light from an emitter 388. In alternate embodiments, only one set of emitters can be used.

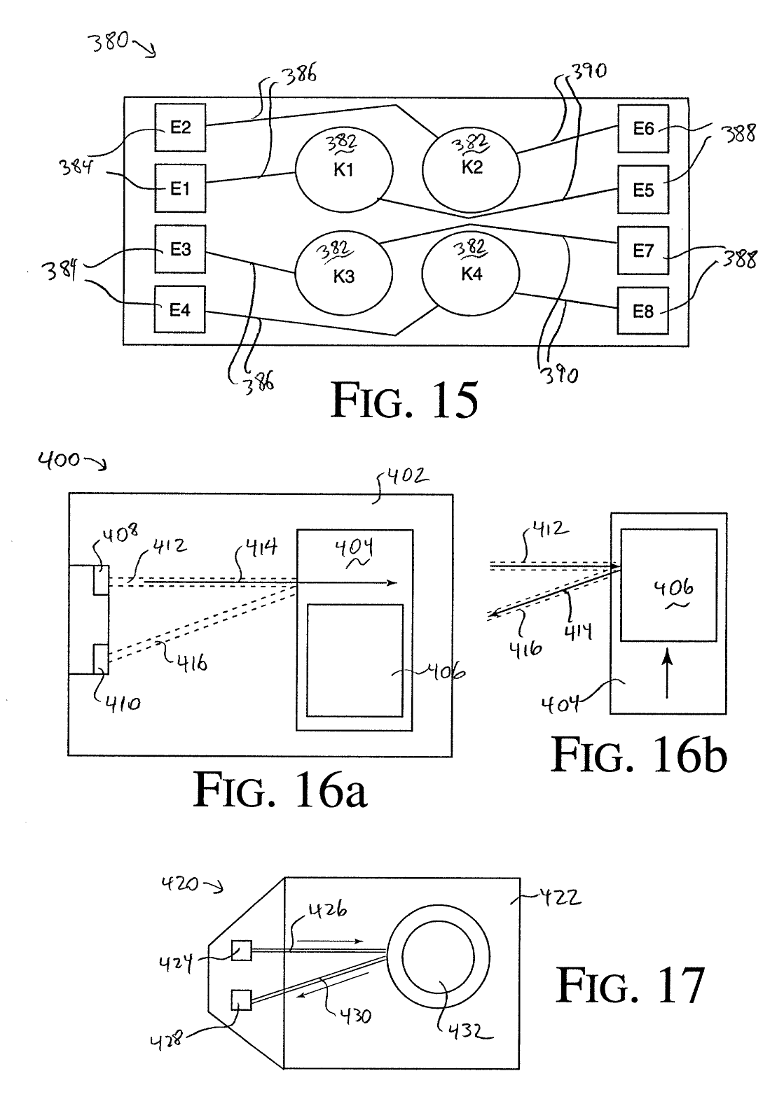

FIG. 16a is a schematic diagram of an optical linear slide switch 400 of the present invention which can be provided in panels. A panel 402 is preferably made of plastic or other moldable material. A linear track 404 in the moldable material holds a sliding or movable switch 406, which can be toggled or adjusted by a user. An emitter 408 and a detector 410 are positioned in the panel as discrete components or as part of an array similar to the embodiments described above. An integrated emitter channel 412 directs a beam 414 of light from the emitter 408 to the track 404. An integrated detector channel 416 is routed from the detector to the point where the channel 412 ends at the track 404. The light beam is modulated as follows. When the switch 406 is in the off position as shown in FIG. 16a, the beam 414 is directed into the track or is otherwise routed away from the detector channel 416. When the switch 406 has been moved to a position that impedes the path of beam 414, e.g. slid upward as shown in FIG. 16b, the beam 414 reflects off a mirrored or polished surface of the side of the switch and is directed down the channel 416 to the detector 410, where the change in switch state is detected. In other embodiments, additional emitters, detectors, and channels can be included to allow the detection of multiple states of the switch 406. Furthermore, an optical encoder pattern can be used to detect the position of the switch 406 and/or two detectors used for direction sensing, as described in the embodiment of FIG. 5. Rocker switches can also be used instead of linearly-moving switches. In still other embodiments, a transmissive type of encoder can be provided, where an emitter located on the opposite side of the switch 406 emits light to the detectors and the light is modulated by gaps in the side of the switch, similar to the embodiment of FIG. 3a.

Optical switches such as shown in FIGS. 16a and 16b have several advantages over electrical switches. The optical switches are very low cost, since the channels are easily molded in the panel and the emitter and detector components are very common. The only moving part of the switch is the sliding element 406. If panel illumination is provided, the emitter than provides panel illumination can in some embodiments also provide the source light for the switch detection. The switch has long life since there are not electrical contact points, and has extreme environmental resistance, since it is sealed into the panel and is resistant to contamination. The optical circuit also is unaffected by any form of electromagnetic interference, such as EMI, RFI, or ESD. Remote location of electrical components can also protect users from electrical shock risk in particular environments, such as wet environments, or explosion risk in combustible environments.

FIG. 17 is a schematic diagram of an optical rotary switch 420 of the present invention. Similar to the switch shown in FIG. 16a, switch 420 includes a panel 422, an emitter 424, an emitter channel 426, a detector 428, and a detector channel 430. A rotating, circular knob 432 is provided for the user to rotate. The knob 432 can include a reflective surface on part(s) of its circumference, and a non-reflecting surface on other parts of its circumference. The knob can thus be rotated to different positions to modulate the emitted beam reflected to the detector. Multiple detectors 428 can be provided at different locations to allow multiple different settings of the knob to be detected. The knob can also be provided with an optical encoder pattern as described with reference to FIG. 1 to allow the precise position of the knob to be determined. A transmissive switch or encoder can alternatively be used, similar to te encoder as shown in FIG. 3a.

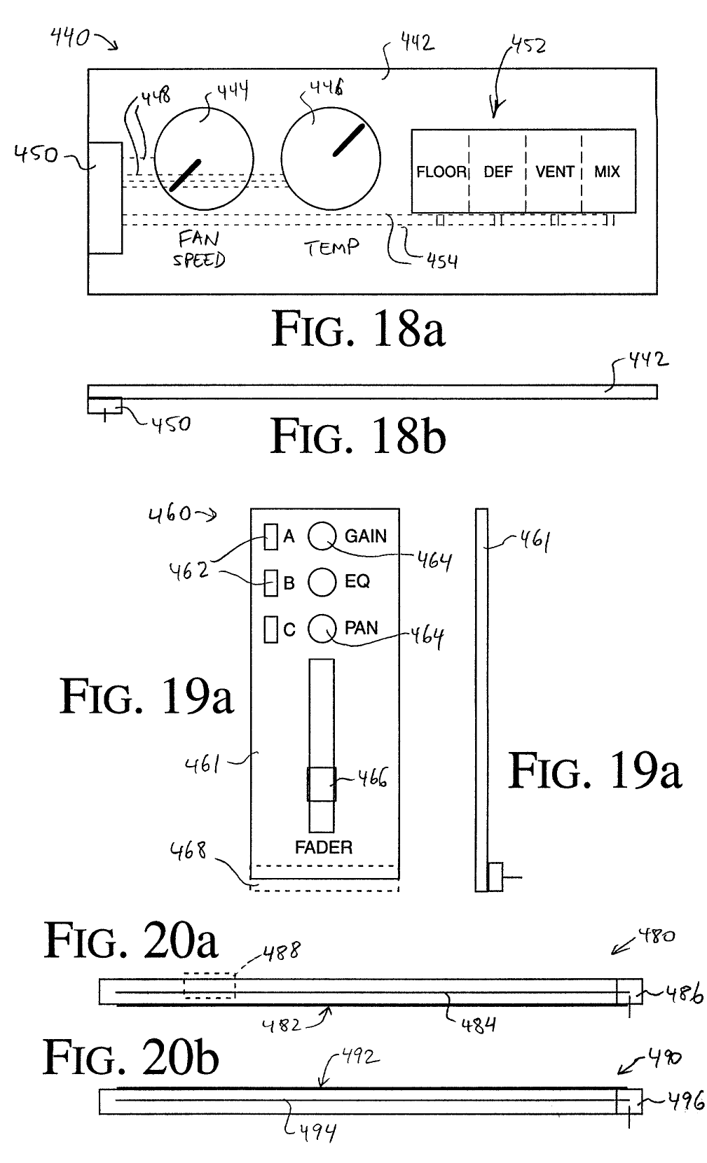

FIGS. 18a and 18b are top plan and side elevational views, respectively, of an example of an automotive control panel 440 that can employ the optical encoders and switches of the present invention. Control panel 440 is commonly integrated into a dashboard of a vehicle, for example. Panel 440 may be rigid or flexible, and may be adhered to a flat or curved surface. Panel 440 may be backlighted by one set of emitters (e.g. LEDs) in the array; light is uniformly distributed. Each switch 452 (see below) may be selectively illuminated by other emitters, which illuminate the switch when the switch position is selected.

The front plate 442 of the panel 440 includes a number of knobs 444 and 446 and keyswitches 452. Knobs 444 and 446 are used to control functions such as fan speed and temperature. These knobs are thus preferably provided as rotary optical encoders similar to the embodiments of FIGS. 1 and 4. Channels 448 conduct light between the knobs 444 and 446 and an emitter-detector array 450, which is preferably the sole electrical connection point to the panel 440. Preferably, each knob is linked to the array 450 by three channels: one to conduct light from an emitter to an encoder pattern on the knob, and two others to conduct phased light back to detectors for magnitude and direction of rotation sensing.

On-off keyswitches 452 are linked to array 450 by channels 454 that form a matrix, in which emitters and/or detectors sequentially scan the switches for activity. Switches 452, for example, can control air routing in the vehicle. The switches 452 may take a variety of forms, including a linear sliding switch (FIG. 16), rocker switch, break or make beam switches (FIG. 10 and 11), momentary switches, etc., as required by ergonomic and/or styling considerations. Output signals from the array are digital signals that are input to a microcontroller, which decodes the signals and provides actual control voltages to effect changes in the vehicle function output. The optical switches of the present invention are advantageous in that no space behind the panel 440 is required for wiring or other components, allowing more comapact designs. There is also reduced risk of electrical leakage and shock.

FIGS. 19a and 19b are top plan and side elevational views, respectively, of an example of an audio mixer channel module 460 suitable for use with the optical encoders and switches of the present invention. In many digitally controlled mixers, audio signals are not brought through the module, but are remotely adjusted and switched by a microcontroller in response to movements of the panel controls. Module 460 includes a plastic panel 461. Module 460 includes a number of latching switches 462, rotary potentiometers 464 for selecting gain, equalization, and other parameters, and a sliding attenuator 466 for master channel gain adjustment. The attentuator 466 can be a linear sliding switch as described with reference to FIG. 16. Optical circuitry (not shown) is included in the panel 461 and an emitter/detector array 468 is provided, similarly to embodiments described above. The panel 461 can be backlit, each control can be selectively lighted, and all switches and potentiometers (knobs) can be sensed through light pipes such as optical channels as described above, where optical channels in the plastic panel conduct light between each control and the array 468. The array converts optical signals to electrical values, which are then routed to a microcontroller, which remotely performs the switching and adjusting tasks according to the movement of the controls by the user. Optical circuits are advantageous in an audio module 460 since they are insensitive to electrical interference.

FIG. 20a shows a side elevational view of a hybrid panel 480 including integrated electrical and optical circuitry. Panel 480 includes an electrical circuit pattern 482 on the bottom of the panel. The pattern 482 can be printed on the panel according to well-known techniques. In addition, a molded optical channel 484 is embedded and integrated in the panel 482 for directing light beams. An array 486 of emitters and detectors can be coupled to or included in the panel as in the embodiments described above. A moveable push button 488 can be mounted in a recess in the panel and be spring loaded, so that downward pressure on the button closes a pair of contacts on the bottom electrical circuit, signaling a switch closure. Sliding switches may be mounted on panel 480 in a similar manner.

FIG. 20b shows a side elevational view of a hybrid panel 490 including integrated electrical and optical circuitry similar to the panel of FIG. 20a, except that electrical circuit pattern 492 is printed on the top of the panel 490. Pattern 492 may include a membrane keypad structure, which incorporates its own shorting-type keyswitches. The embedded optical channel 494 and emitter/detector array 496 can direct light for encoder-type controls or encoder sensors, as well as illuminate the panel and controls. In some embodiments, the electrically-conductive elements might be limited to specific sections of the panel surface where their optical opacity does not interfere with other optical panel functions.

The combining of conventional printed circuit boards and optical panels as in the embodiments of FIGS. 20a and 20b offers several advantages. Many techniques have been devised for the low-cost mass production of flat-panel electrical circuitry. When combined with the optical panel circuitry described herein, optimization can be achieved with respect to functionality, cost-effectiveness, structural integrity, and other factors. In alternate embodiments, rather than having electrical traces printed directly on the surface of the panel, the panel 480 or 490 may be assembled from multiple laminated layers, as is a typical membrane keyboard, where each layer can include electrical traces.

Hybrid circuits of this type may be more economical and practical in multifunction panels, in which encoder/potentiometers, as well as all illumination, might be linked to the emitter/detector array through light channels, as described above, and binary switches can be implemented as a simple shorting bar that contacts a printed electrical matrix, as is done in conventional membrane keypads.

While this invention has been described in terms of several preferred embodiments, there are alterations, modifications, and permutations thereof which fall within the scope of this invention. It should also be noted that the embodiments described above can be combined in various ways in a particular implementation. Furthermore, certain terminology has been used for the purposes of descriptive clarity, and not to limit the present invention. It is therefore intended that the following appended claims include such alterations, modifications, and permutations as fall within the true spirit and scope of the present invention.

What is claimed is:

1. An optical sensor comprising:
a substrate;
a moving member having an encoder pattern;
an emitter outputting a beam of electromagnetic energy;
a detector channel integrated in said substrate, said detector channel receiving said beam of electromagnetic energy when said encoder pattern permits said beam to reach said detector channel; and
a detector located remotely from said encoder pattern and optically coupled to said detector channel, said detector receiving said beam of electromagnetic energy from said detector channel and operative to output an electronic signal indicating that said beam is being detected.

2. An optical sensor as recited in claim 1 wherein said emitter is located remotely from said encoder pattern, and further comprising an emitter channel integrated in said substrate and optically coupled to said emitter, said emitter channel directing said beam of electromagnetic energy from said emitter to said encoder pattern on said moving member.

3. An optical sensor as recited in claim 1 wherein said moving member includes a wheel rotatable about an axis.

4. An optical sensor as recited in claim 1 wherein said moving member includes a linearly-moving member.

5. An optical sensor as recited in claim 1 wherein said moving member pattern includes a number of gaps and a number of blocking portions, wherein said gaps allow said beam to be transmitted to said detector channel.

6. An optical sensor as recited in claim 1 wherein said encoder pattern includes a number of portions having a reflective surface and a number of portions having a less reflective surface such that said beam is reflected to said detector, wherein said reflectivity of said two types of portions is different enough to allow said detector to discriminate between said reflected beams.

7. An optical sensor as recited in claim 1 wherein said substrate is made of plastic transparent to said beam.

8. An optical sensor as recited in claim 7 wherein said detector channel is molded in said substrate, such that at least one wall of said channel is reflective.

9. An optical sensor as recited in claim 8 wherein at least two walls of said detector channel are bordering an air gap in said substrate.

10. An optical sensor as recited in claim 1 wherein said emitter and said detector are integrated in a lead frame array.

11. An optical sensor as recited in claim 1 wherein walls of said detector channel are members inserted into said substrate.

12. An optical sensor as recited in claim 1 wherein said detector is a first detector and said detector channel is a first detector channel., and further comprising a second detector and a second detector channel, wherein said second detector channel directs said beam to said second detector from said encoder pattern when said first detector channel directs said beam to said first detector.

13. An optical sensor as recited in claim 12 wherein said spacing between said first detector channel and said second detector channel provides said beams 90 degrees out of phase with respect to each other to said detectors.

14. An optical sensor as recited in claim 1 wherein said substrate further includes an electrical circuit pattern printed on a surface of said substrate.

15. An optical switch comprising:
a portion of a panel having a recess;
an emitter outputting a beam of electromagnetic energy, said emitter being coupled to said panel and being located remotely from said recess;
an emitter channel integrated in said panel, said emitter channel directing said beam of electromagnetic energy from said emitter to said recess;
a detector channel integrated in said panel, said detector channel receiving said beam of electromagnetic energy in a first state of said switch, and said detector channel not receiving said beam in a second state of said switch; and
a detector located remotely from said encoder pattern and coupled to said panel, said detector receiving said beam of electromagnetic energy from said detector channel and operative to output an electronic signal indicating one of said states of said switch.

16. An optical switch as recited in claim 15 wherein said detector channel receives said beam when a user causes an object to be placed in said recess such that said beam is reflected to said detector channel.

17. An optical switch as recited in claim 16 wherein said object placed in said recess is a finger of said user.

18. An optical switch as recited in claim 15 wherein said detector channel constantly receives said beam from said emitter until a user causes an object to be placed in said recess such that said beam is broken and said detector no longer receives said beam.

19. An optical switch as recited in claim 18 wherein said object placed in said recess is a finger of said user.

20. An optical switch as recited in claim 15 wherein said panel is made of plastic transparent to said beam.

21. An optical switch as recited in claim 20 wherein said detector channel is molded in said substrate, such that at least one wall of said channel is reflective.

22. An optical switch as recited in claim 15 further comprising an illumination channel molded in said panel, said illumination channel directing light visible to said user from a second emitter located remotely from said recess, said visible light illuminating said recess when one of said states is entered.

23. An optical sensor comprising:
a flexible ribbon;
a moving member having an encoder pattern;
an emitter outputting a beam of electromagnetic energy, said emitter coupled to said ribbon;
a flexible optical emitter light pipe coupled to said ribbon, said emitter light pipe directing a beam of electromagnetic energy from said emitter to said encoder pattern;
a flexible optical detector light pipe coupled to said ribbon, said detector light pipe receiving said beam of electromagnetic energy when said encoder pattern reflects said beam to reach said detector light pipe; and
a detector located remotely from said encoder pattern and coupled to said substrate, said detector receiving said beam of electromagnetic energy from said detector channel and operative to output an electronic signal indicating that said beam is being detected.

24. An optical sensor as recited in claim 23 wherein said detector is a first detector and said detector channel is a first detector channel., and further comprising a second detector and a second detector channel, wherein said second detector channel directs said beam to said second detector from said encoder pattern when said first detector channel directs said beam to said first detector.

25. An optical sensor as recited in claim 23 wherein said flexible ribbon includes apertures spaced regularly along a length of said ribbon.

26. An optical sensor as recited in claim 23 wherein said flexible emitter light pipe and said flexible detector light pipe are laminated to said ribbon.

27. An optical switch comprising:
a moveable control movably coupled to a panel, said control manipulable by a user;
an emitter outputting a beam of electromagnetic energy, said emitter being coupled to said panel and being located remotely from said control;
an emitter channel integrated in said panel, said emitter channel directing said beam of electromagnetic energy from said emitter to said control;
a detector channel integrated in said panel, said detector channel receiving said beam of electromagnetic energy when said control modulates said beam; and
a detector located remotely from said control and coupled to said panel, said detector receiving said beam of electromagnetic energy from said detector channel and operative to output an electronic signal indicating a state of said switch.

28. An optical switch as recited in claim 27 wherein said modulation includes moving said moveable control in a path of said beam such that said beam is reflected to said detector channel.

29. An optical switch as recited in claim 27 wherein said modulation includes moving said moveable control such that said beam from said emitter is allowed to be received by said detector channel and said detector.

30. An optical switch as recited in claim 27 wherein said control is a rotary knob.

31. An optical switch as recited in claim 27 wherein said control is a linear-moving control, wherein said beam is modulated when said control is moved in a pathway of said beam.

32. An optical switch as recited in claim 27 wherein said panel is made of plastic transparent to said beam.

33. An optical switch as recited in claim 32 wherein said detector channel is molded in said substrate, such that at least one wall of said channel is reflective.

34. An optical switch as recited in claim 27 wherein said detector is a first detector and said detector channel is a first detector channel, and further comprising a second detector and a second detector channel, wherein said second detector channel directs said beam to said second detector and receives said beam when said control modulates said beam.

35. A method for optically detecting motion of a member, the method comprising:
outputting a beam of electromagnetic energy from an emitter to an encoder pattern coupled to said member;
directing said beam of electromagnetic energy from said encoder pattern to a detector located remotely from said encoder pattern, wherein said beam is directed through said substrate by a channel integrated in said substrate, wherein said channel receives said beam when said encoder pattern permits said beam to reach said channel; and
outputting an electronic signal indicating that said beam has been detected.

36. A method as recited in claim 35 further comprising directing said beam output from said emitter through said substrate by an emitter channel integrated in said substrate to said encoder pattern.

37. A method as recited in claim 35 wherein said encoder pattern reflects said beam to said channel.

38. A method as recited in claim 35 wherein said encoder pattern either blocks said beam or permits said beam to be directly transmitted from said emitter to said channel.
